(19) United States
(12) Patent Application Publication
(10) Pub. No.: US 2018/0286255 A1
(43) Pub. Date: Oct. 4, 2018

(54) AUTONOMOUSLY OPERATED DIRIGIBLE

(71) Applicant: Above Daas, Inc., Phoenix, AZ (US)

(72) Inventors: Dirk Karsten Beth, Phoenix, AZ (US); Austin Jess Burch, Austin, TX (US)

(21) Appl. No.: 15/945,543

(22) Filed: Apr. 4, 2018

Related U.S. Application Data
(60) Provisional application No. 62/481,493, filed on Apr. 4, 2017.

(51) Int. Cl. G08G 5/00; G05D 1/04; B64D 43/02; B64C 39/02

(52) U.S. Cl. CPC G08G 5/0039; G08G 5/0091; G01C 21/16; B64D 43/02; B64C 39/024; G05D 1/042

(57) ABSTRACT

Propulsion of an unmanned vehicle may include determining and ordering a subset of altitude-differentiated wind vectors, the subset facilitating directional air flow from a starting geographic region to a destination geographic region, and configuring the vehicle and adjusting the altitude of the vehicle to the altitude corresponding to each of the subset of wind vectors as ordered based on a flight plan that includes at least one of a duration and distance for each of the ordered subset of the wind vectors.

### CLAIM TO PRIORITY

This application claims the benefit of the U.S. provisional patent application Ser. No. 62/481,493 filed Apr. 4, 2017, which is hereby incorporated by reference in its entirety.

### BACKGROUND

### Field

The methods and systems described herein generally relate to design and operation of a gas chamber aerial vehicle, such as a dirigible.

### Description of the Related Art

Unmanned dirigible-type vehicles generally operate through use of forced propulsion, such as with propellers and the like. There remains a need for such vehicles that can operate independent of forced propulsion.

### SUMMARY

Operating unmanned vehicles over long distances and/or for long durations present challenges, including fuel supply management. The methods and systems of autonomously operated aircraft, such as dirigible-type aircraft described herein provide advantages in weight, fuel efficiency, payload management, materials, and the like over emerging aircraft technologies.

An aircraft may include at least one lift gas chamber the content of which may be produced by a hydrogen production system that may be solar powered, or may be replenished from a reserve hydrogen tank. Operation of the aircraft may be controlled by processor executing a navigational algorithm based on air flow data for a plurality of altitudes. The aircraft operation, such as for efficient operation, may be further be adjusted using a payload shuttle that is moveable across a portion of an underside of the aircraft. To facilitate payload unloading and loading, the aircraft may also be equipped with a payload elevator may be that facilitates movement below the aircraft. The lift gas chamber may be adjustable in size and/or may include a pressure-based relief panel.

The algorithm that controls aircraft operation may facilitate adjusting an altitude of the aircraft to use air flow as a primary source of forward propulsion.

The payload shuttle may be moveable in response to detected imbalances of a payload being carried by the aircraft. The payload elevator may include at least one landing platform for another aircraft, such as a helicopter.

These and other systems, methods, objects, features, and advantages of the present disclosure will be apparent to those skilled in the art from the following detailed description of the preferred embodiment and the drawings.

In embodiments, point to point wind surfing by an unmanned vehicle may include a method of propulsion that takes advantage of winds at different altitudes. Such a method may include detecting a plurality of altitude differentiated wind vectors. The method may also include determining and ordering a subset of the wind vectors that provide directional air flow from a first geographic region to a second geographic region. Additionally, the method may include configuring the unmanned vehicle for facilitating movement of the vehicle along a first vector of the plurality of wind vectors, followed by adjusting an altitude of the vehicle to correspond to an altitude of the first wind vector. The method may repeat the configuring and adjusting for the subset of plurality of wind vectors based on a flight plan that may include at least one of a duration and distance for each of the ordered subset of the wind vectors. In embodiments, detecting a plurality of altitude differentiated wind vectors may be based on a weather map. In embodiments, the flight plan may be based on a combination of weather maps, airspace occupancy information for at least a portion of the airspace along the flight plan, and weather conditions sensed proximal to the vehicle. The flight plan may also include at least one location for adjusting an altitude of the vehicle for each of the subset of wind vectors. The at least one location may be a location of entry into the wind vector or a location of exit from the wind vector. In embodiments, the at least one location may be based on air pressure. In embodiments, adjusting altitude may include adjusting a buoyancy of the vehicle. In embodiments, adjusting altitude may also include adjusting a shape of a portion of the vehicle to induce at least one of differential air pressure lift or altitude reduction. In embodiments, the flight plan may be based on at least two of air temperature, air pressure, relative humidity, barometric pressure, temporal wind patterns, cloud patterns, target destination arrival time. In embodiments, the flight plan may be based on at least two of terrain along the travel route, manmade structures, flight timing, aircraft traffic patterns, and classification of airspace at a plurality of altitudes. In embodiments, the method may include adjusting the flight plan based on updates to information on which the flight plan may be based, including conditions proximal to the vehicle that are sensed by vehicle-mounted sensors. The vehicle mounted sensors that facilitate adjusting the flight plan may include directional pilot tubes that may be configured to produce a three-dimensional airspeed vector. In embodiments, the flight plan may be based on a measure of external forces acting on the vehicle and the measure of external forces may include dead reckoning information generated by data gathered with an Inertial Measurement Unit mounted to the vehicle. In embodiments, configuring the unmanned vehicle may include orienting the vehicle to receive the wind along a broad side of the vehicle. In embodiments, configuring the unmanned vehicle may include applying preconfigured drag and lift coefficients to a vehicle orientation algorithm that determines an external portion of the vehicle to receive the wind and adjusting the vehicle orientation so that the determined external portion receives the wind. In embodiments, configuring the unmanned vehicle may include controlling wind-induced rotation of at least one propulsion rotor with variable braking forces.

In embodiments, surveillance based wind surfing by an unmanned vehicle may include a method of propulsion that takes advantage of winds at different altitudes. Such a method may include determining altitude differentiated wind patterns proximal to a surveillance region. The method may also include ordering a portion of the wind patterns to facilitate navigation over the surveillance region. The method may also include configuring a propulsion system of an unmanned vehicle for facilitating movement of the vehicle along a first pattern of the portion of the wind patterns and adjusting an altitude of the vehicle to correspond to an altitude of the first wind pattern in the portion of wind patterns. The method may repeat the configuring and adjusting for the ordered set of wind patterns based on a surveillance plan that may include at least one of a duration and distance for each of the ordered portion of the wind patterns. In embodiments, the surveillance plan may include at least one location for adjusting an altitude of the vehicle for each of the portion of wind patterns. The at least one location may be a location of entry into a wind pattern or an exit from a wind pattern. In embodiments, the at least one location may be based on air pressure. In embodiments, adjusting altitude may include adjusting a buoyancy of the vehicle. It may also include adjusting a shape of a portion of the vehicle to induce at least one of differential air pressure lift or altitude reduction. In embodiments, the surveillance plan may be based on at least two of air temperature, air pressure, relative humidity, barometric pressure, temporal wind patterns, cloud patterns, target destination arrival time. In embodiments, the surveillance plan may be based on at least two of terrain along the travel route, manmade structures, flight timing, aircraft traffic patterns, and classification of airspace at a plurality of altitudes. In embodiments, the method may further include adjusting the surveillance plan based on updates to information on which the surveillance plan may be based, including conditions proximal to the vehicle that are sensed by vehicle-mounted sensors. The vehicle mounted sensors that facilitate adjusting the surveillance plan may include directional pilot tubes that may be configured to produce a three-dimensional airspeed vector. In embodiments, the surveillance plan may be based on a measure of external forces acting on the vehicle and the measure of external forces may include dead reckoning information generated by data gathered with an Inertial Measurement Unit mounted to the vehicle. In embodiments, configuring the unmanned vehicle may include orienting the vehicle to receive the wind along a broad side of the vehicle. In embodiments, configuring the unmanned vehicle may include applying preconfigured drag and lift coefficients to a vehicle orientation algorithm that determines an external portion of the vehicle to receive the wind, and adjusting the vehicle orientation so that the determined external portion receives the wind. In embodiments, configuring the unmanned vehicle may include controlling wind-induced rotation of at least one propulsion rotor with variable braking forces.

In embodiments, a method of calibrating vehicle mounted sensors may include detecting via image analysis at least one tower and one segment of power line and determining a low point of the segment of the power line. The method may further include assigning a location and gravity vector to the determined low point, and applying the gravity vector to calibration of a plurality of sensor types for sensors deployed on the vehicle. At least one of the plurality of sensor types may be an Inertial Measurement Unit (IMU). In embodiments, applying the gravity vector to calibration may include drift zeroing.

In embodiments, a method of aligning two types of image data may include capturing a visual image of at least one tower and one segment of power line. The method may include capturing a thermal image of the at least one tower and one segment of the power line. The method may further include determining a low point of the segment of the power line through analysis of the visual image and assigning a location and gravity vector to the determined low point. Additionally, the method may include aligning the visual image and the thermal image based on at least one of the location and gravity vector assigned to the determined low point.

In embodiments, a method may include taking a plurality of sets of sensor data from a plurality of different types of sensors and determining a gravity vector for at least one of the plurality of sets of sensor data based on a low point of a power line detected in any of the plurality of sets of sensor data. The method may include determining a location of the gravity vector and aligning at least a portion of the plurality of sets of sensor data into a fused stack of sensor data based on the location of the gravity vector. In embodiments, the plurality of sets of sensor data are time synchronized. In embodiments, a power line may be detected by detection of at least one of transmission line posts, pipeline flanges, and a low point of a power line within a segment of a transmission power grid. In embodiments, the method may further include performing z-stack correlative three-dimensional reconstruction of the plurality of sets of sensor data resulting in a multimodal data set comprising visual image data, thermal image data, and at least one other data type from at least one of the different types of sensors.

In embodiments, a vehicle may include a plurality of sensors wherein at least two of the plurality of sensors comprise different types of sensors. A first sensor of the plurality of sensors of a first type may be disposed on an outer surface of a gas envelope of the vehicle proximal to a nose of the vehicle. A second sensor of the plurality of sensors of a first type may be disposed on the outer surface of the gas envelope of the vehicle proximal to a tail of the vehicle, so that data output from the first sensor and from the second sensor may be combined into a stereo image of a land-based object. The system may further include a sensor fusion facility that includes a processor that processes a data set from a sensor of a second type of the different types of sensors with the stereo image thereby producing a multi-mode image comprising visual and at least one other type of data. In embodiments, the first type of sensor may be an image sensor. In embodiments, the second type of sensor may be a thermal sensor. Yet in further embodiments, the first type of sensor may be an image sensor and the second type of sensor may be a thermal sensor. In embodiments, the multi-modal image includes visual image data and thermal image data, wherein the thermal image data may be aligned with the visual image data based on preconfigured alignment of the first and second types of sensors.

All documents mentioned herein are hereby incorporated in their entirety by reference. References to items in the singular should be understood to include items in the plural, and vice versa, unless explicitly stated otherwise or clear from the text. Grammatical conjunctions are intended to express all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a perspective view of an embodiment of dirigible-type unmanned aircraft.

FIG. 2 depicts an embodiment of directing an aircraft based on air-currents.

FIG. 3 depicts an embodiment of a thrust directing louvered, rotatable bezel.

FIG. 4 depicts an embodiment of an aircraft with moveable payload shuttle.

FIG. 5 depicts embodiments of safety features of a gas lift-based aircraft.

FIG. 6 depicts an extendable reservoir for a gas lift-based aircraft.

FIG. 7 depicts a visualization of a gore.

FIG. 8 depicts an example of arc segments of a multi-gore design front view.

FIG. 9 depicts geometry of a gore projected onto a 2D plane

FIG. 10 depicts geometry of an envelope profile side view

FIG. 11 depicts a side and front view of an aircraft as described herein.

FIG. 12 depicts a payload shuttle elevator embodiment of an aircraft described herein.

FIG. 13 depicts an embodiment of deployable environmental sensors of an embodiment of the aircraft described herein.

FIG. 14 depicts a portion of a selective multi-thickness wall of an aircraft lift gas chamber.

FIG. 15 depicts material layering of a 3 gore envelope.

FIG. 16 depicts gore alignment after layering material.

FIG. 17 depicts a carbon fiber frame of an envelope.

### DETAILED DESCRIPTION

Described herein and depicted in the accompanying figures are methods and systems for efficiently operating unmanned aircraft that can fly for long distances and/or long duration with low fuel demand while supporting large/heavy payload plus remote payload pickup and delivery while in-flight. Such an aircraft may provide goods transportation over long distances at much greater efficiency than existing aircraft-based transportation means. This efficiency is accomplished using air current-based sensing for efficient navigation along with improvements in aircraft materials and payload compensation, among other methods and systems described herein.

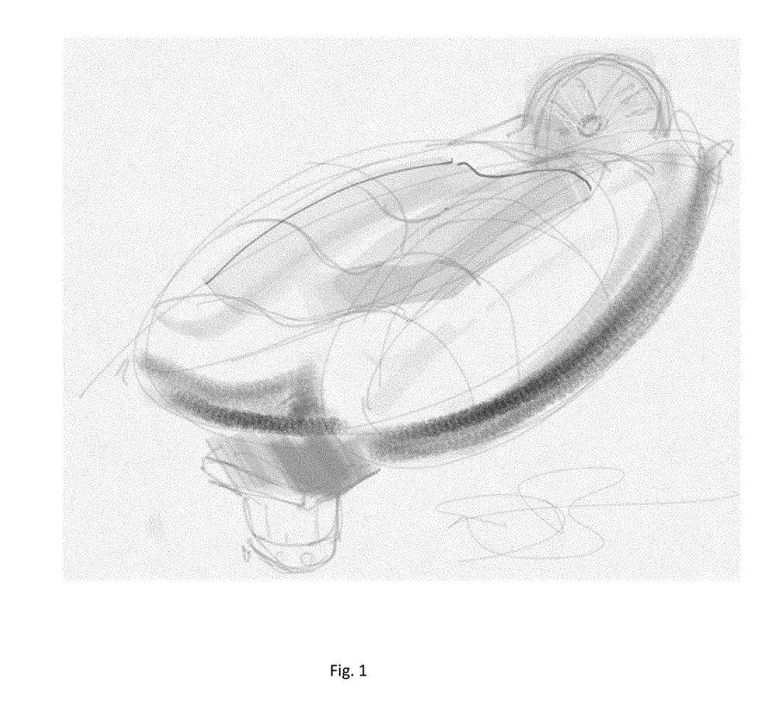

Referring to FIG. 1, which depicts a perspective three-dimensional view of a dirigible-based aircraft, features such as a payload elevator, expandable gas lift chambers, louver-based propulsion, environmental sensors, catamaran-style body and the like may be combined in an aircraft of a wide range of sizes. Aircraft sizes may be based on lift capacity, lift fuel source, and the like.

In embodiments, lift of such an aircraft may be provided by a lighter-than-air gas, such as helium, hydrogen, and the like. Hydrogen may provider greater lift per unit volume due at least in part to it being lighter than helium. Altitude may be adjusted through a combination of adjusting the volume of lift-gas used, directional control of a rotary engine (e.g., fan-based), and the like. Lift-gas volume may be increased through a gas generation facility onboard the aircraft. For embodiments that use hydrogen as the lift gas, a hydrolysis system (e.g., a system that produces hydrogen from ambient air moisture) may be used. Such a hydrogen producing system may be solar powered to further increase fuel efficiency. Lift-gas volume may be reduced, such as through the use of ballonets and the like, thereby reducing lift with the intention of moving the aircraft to a lower altitude may be accomplished by venting the lift-gas into the environment. Because lift demand for a fixed payload may change based on altitude, atmospheric pressure, temperature, amount of sun radiating on the aircraft, and the like, lift-gas production or reduction may be automatically adjusted to maintain a given altitude in addition to changing altitude. Lift-gas capacity or maximum volume may be based on an anticipated maximum payload weight. In embodiments, aircraft with high payload weight limits may have a lift-gas capacity of 12 to 20 blocks or more (one block equates to 1000 cubic feet of gas), or possibly less. Size and shape of the lift-gas chambers may also vary depending on a desired aspect ratio of the aircraft. For small footprint aircraft, lift-gas chambers may be vertically elongated. For narrow footprint aircraft, lift gas chambers may be narrow in one horizontal direction (e.g., side to side), but long in another (e.g., front to back). For an aircraft with unbounded footprint requirements, a generally oblong shape may be chosen to facilitate reducing head wind impact, and the like.

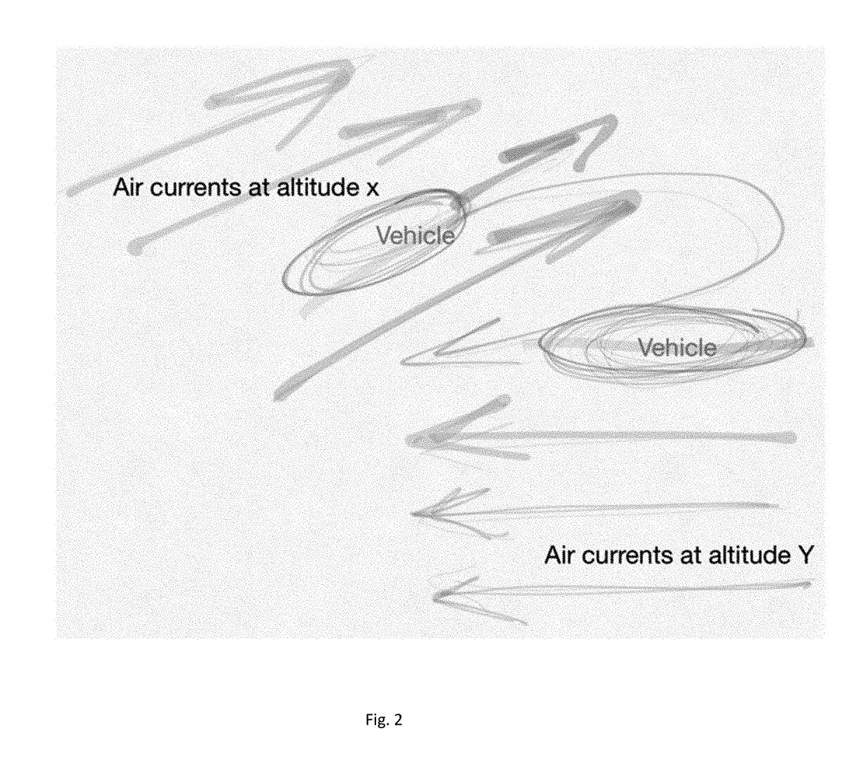

Referring to FIG. 2 that depicts an embodiment of methods and systems for directing an aircraft based on active wind direction sensing, a form of air current sensing and compensation for navigation is presented to achieve a primary objective of aircraft generally to move freely through the air from one location to another, such as to transport a payload from one location to another, to perform surveillance and the like.

In embodiments, a dirigible-type aircraft may gain altitude efficiently using lift-gas; however, propulsion to get from here to there using combustible fuel may present certain challenges due to the shape and size of the aircraft. Methods and systems described herein for air current surfing may instead take advantage of the lift-efficient properties of such an aircraft to deliver greater propulsion efficiency. One such approach involves taking into consideration the wind currents present in the environment during flight.

Wind current surfing may include mapping a flight path from a source to a destination based on prevailing winds at different altitudes. Current navigation algorithms generally work to avoid head winds for aircraft at least because headwinds reduce speed while increasing flight time and fuel consumption. The inventive navigation methods and systems described herein may look at prevailing winds across a spectrum of altitudes during flight planning and in-flight for navigation. Because a dirigible-type aircraft can be pushed along by winds efficiently, a navigation algorithm may calculate locations along a route for changing altitude to take advantage of favorably directed prevailing winds. In an example of wind current surfing, to travel in a generally southwest direction, a wind current surfing navigation algorithm may identify a plurality of locations (e.g., GPS coordinate-based and the like) where the aircraft will change altitude to use the prevailing winds effectively for propulsion. In this example, the aircraft may climb to a first altitude to catch westerly winds for a first duration and then move to a second altitude to catch southerly winds for a second duration. The aircraft may change altitudes several times during flight to make its way to the destination. Although the total distance traveled may be significantly greater than a most efficient flight path from the source to the destination, due to the use of prevailing winds as propulsion, significant fuel efficiency may be achieved.

A variety of factors may be used in a navigation algorithm. Air temperature, air pressure, relative humidity, barometric pressure, temporal wind patterns, time of year (e.g., seasonal impact on environment along a route), cloud cover patterns and predictions, weather forecasts, third-party data used to make weather predictions, and the like may be factored into determining a route for navigation. In an example, moving from a space with lower air temperature to a space with higher air temperature may facilitate increasing lift. Changes in air pressure may similarly be used for optimizing a navigation route that may improve fuel efficiency in that a higher air pressure environment may require lift gas to maintain a flight altitude than may be required in a lower air pressure environment. Other factors to consider in navigation optimization may include terrain, manmade structures, buildings, flight timing, GPS and other geo-spatial location information, other aircraft, aircraft traffic patterns, classification of airspace at varying altitudes, and the like.

The wind data and any other data desirable for use in a navigation optimization algorithm may be sourced from a combination of sensors on the aircraft and/or externally disposed sensors. Local and national weather monitoring and forecasting data sources may be used as well. Computing for such navigation optimization may be performed by processors disposed with the aircraft, external processors, such as land-based processors and the like. Data from other sources, such as weather balloons, satellites, land-based weather monitoring systems, and the like may also be used.

Flight planning may be performed prior to flight, during flight, directly in response to locally sensed conditions proximal to the aircraft and the like. As an example, an initial flight path may be prepared prior to flight based on forecasts. During flight, as forecasts are updated, the initial flight path may be updated or even replaced based on a degree of change of forecast. Longer duration flights may include flight plan changes due to changes in long range forecasting. Confidence of flight path plans may be based on how far ahead the information is forecasted. Since shorter range forecasts generally have high confidence, a flight plan based on these forecasts may be considered more reliable, such as for determining a cost effective path. The use of local weather conditions, either through sensing directly by sensors on or proximal to the aircraft, or through external weather monitoring sources, may result in dynamic flight plan changes. As an example, if local conditions indicate that cloud cover is lifting in the general area of the aircraft, flight and operational control of the aircraft may be adjusted to take advantage of the greater portion of sunlight impacting the aircraft.

In embodiments, during path planning, updating, and review, such as when a vehicle is taxiing from one mission to the next, navigation and route planning may make use of weather forecasting to produce wind current maps. These maps may be fused with a three-dimensional airspace occupancy grid of obstacles (e.g., fixed objects, other vehicles, aircraft, temporary structures, weather balloons and the like) and the like to produce route planning information that may facilitate optimizing paths, such as for minimizing power consumption, maximizing safety and/or speed of travel, and the like. In embodiments, a cost metric for each of a plurality of possible routes may be calculated. Such a metric may include monetary costs that may relate to aspects such as costs of flight personnel based on a duration of flight and the like, financial costs associated with level of service contracts and the like (e.g., penalties for delay of delivery, and the like), fuel consumption costs, air space leasing costs, and the like. During route planning, this cost metric may be used as a fourth dimensional metric and may be a weighted function of the cost metric for each path generated. In embodiments, route optimization with these parameters in mind, may facilitate navigating the vehicle along an optimized route that may factor in aspects other than cost including metrics of wind current and weather that affect the travel dynamics of the vehicle. In embodiments, flight planning, navigation and the like may be based on wind surfing control algorithms that take into account upper level atmosphere weather maps, lower level wind vector sensing, and the like. In embodiments, flight planning may incorporate vehicle path optimization based at least in part on weather forecasting and wind current projections.

Gravitational forces can also be factored into a navigation plan. An aircraft that has a shape of a wing, or can be configured to emulate a wing or the like may use gravity to cause forward propulsion by allowing the aircraft to descend and converting that downward motion into forward propulsion by way of air pressure differences above and below the wing shape. In this way, movement from a higher altitude wind zone to a lower altitude wind zone that requires traveling between the zones may be accomplished without use of fuel for propulsion.

A similar algorithm may be applied for use of the aircraft for surveillance over a fixed area. Winds over the area to be surveilled can be determined and used in flight planning by adjusting the aircraft altitude to catch winds blowing in a first direction to traverse the area once, then changing altitude to catch winds blowing in substantially the opposite direction to traverse the area again. Alternate flight plans may be developed based on winds that may include flying beyond the target surveillance area to catch winds that bring the aircraft back to perform a supplemental surveillance pass over the target area.

In embodiments, a vehicle may also be capable of determining its surrounding environment's wind vector, include at least one of magnitude and direction, though use of directional pitot tubes and optionally an Inertial Measurement Unit (IMU). The vehicle's pitot tubes may be placed orthogonal to each other, such that an airspeed vector for each of three orthogonal directions (e.g., a three-dimensional airspeed vector) can be constructed. Furthermore, the onboard flight controller may be put into a learning or standby mode in which the IMU is instructed to integrate drift of the vehicle, such as through dead reckoning operations and the like. In this way, external forces acting on the vehicle can be extrapolated to predict the wind's direction. In embodiments, a more accurate wind vector may be calculated through any combination of pilot tube data, dead reckoning, and learning based on detected vehicle drift.

The vehicle's gas chamber(s) may be controlled to achieve a neutral buoyancy state that may enable the vehicle to hover with little, zero or negative energy output to the propulsion motors. This may be advantageous for maintaining, as an example, an airborne state for long durations, such as at night or other conditions when solar power generation is not in progress, or such as when the vehicle is being operated inside a building or other structure.

In embodiments, to obtain movement while remaining in a state of low or zero output to the propulsion system, the surface area of the vehicle's broad side may be utilized to propel the vehicle through its own induced drag forces, such as due to wind. In embodiments, a stabilization control system may make the vehicle capable of maintaining stabilization along a range of axes, including its longitudinal axis, an axis of predominant wind flow, the respective axis of movement direction, and the like. Therefore, the vehicle can not only face perpendicularly to the direction of the wind's currents, but also, through use of at least preconfigured drag and lift coefficient tables for orientation induce directional forces from drag due to the wind current. In embodiments, the drag and lift coefficient tables may be generated through Computational Fluid Dynamics (CFD) and the like and may be based on wind tunnel measurement data. In embodiments, machine learning may be used with CFD and feedback from wind tunnel operation to enhance the draft and lift coefficients for specific combinations of wind, payload, vehicle orientation, vehicle shape and the like. The resultant drag force vector of the vehicle may used by the vehicle control systems to, for example, enable it to direct a path over long distances with minimal energy output, while being tolerant of lateral movement.

In embodiments, the vehicle may be configured to have minimal forward facing drag. By directing its nose in the opposing direction of the determined wind vector, the vehicle may idle whist reducing external forces and increasing longitudinal airflow along the vehicle. This orientation with respect to the wind's direction may result in greater airflow through the vehicle's propellers than other orientations. In embodiments, the propellers are allowed to rotate freely, enabling the rotor drive system to act as a generator instead of a motor. This state may produce a positive net power generation.

In embodiments, variable active breaking due to rotor speed (e.g., revolutions per minute and the like) monitoring, such as through each rotor's motor electronic speed controllers, can induce variable, yet controllable, forces on the propeller faces. These varying external forces and rotor RPM control may induce rotations on the vehicle by increasing more drag in some rotors than others, and in turn, produce a non-collinear velocity force vector with the wind current. In this way, directional flight along the wind current is enabled, while optionally generating power through the propellers acting as wind turbines.

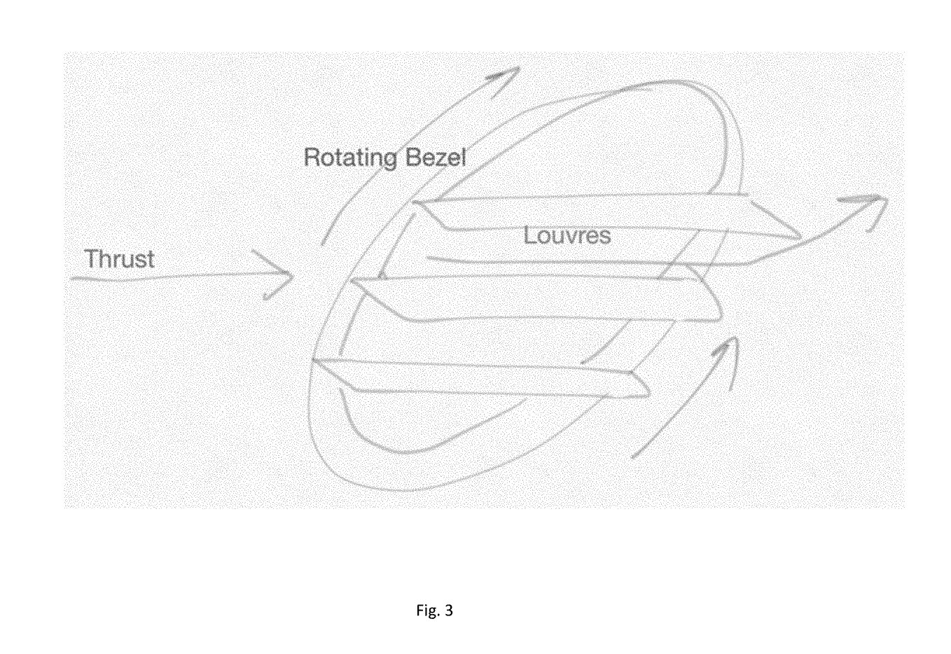

Referring to FIG. 3 that depicts a rotating louvered propulsion direction control device. Dirigibles can fly from one location to another with a simple fan-type rotary engine. By configuring a rotatable louvered bezel for the fan, air provided by such a fan can be directed in any desired direction. Adjusting the louvers from fully closed in a first direction to fully open to full closed in a second direction an aircraft adapted with such a propulsion direction bezel can be directed to move toward the first direction, maintain heading (e.g., substantially open), or toward the second direction. When this two-direction capability is placed on a rotating bezel, the number of potential propulsion directions increases significantly. The aircraft can be directed up, down, left, right, or any combination of up/down with left/right.

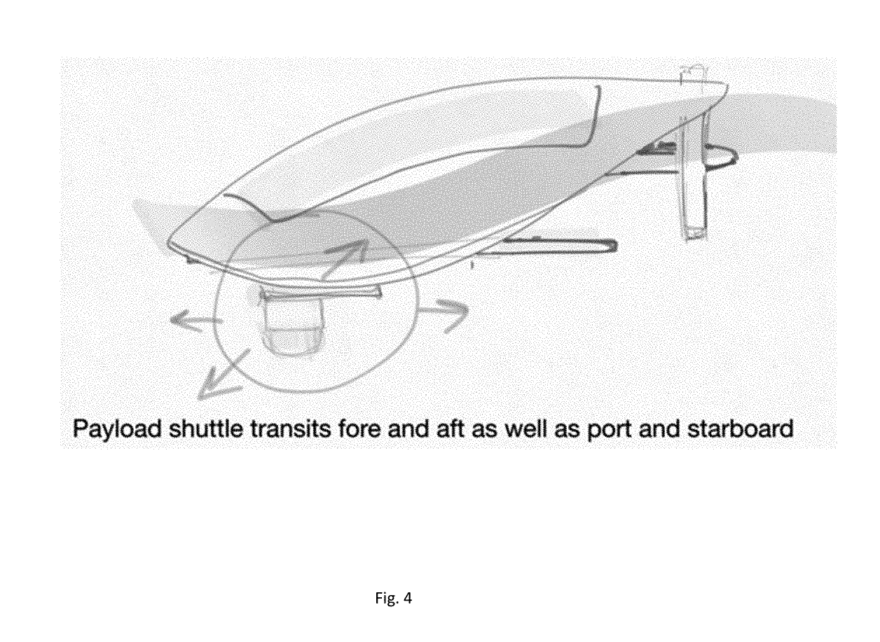

FIG. 4 depicts a payload shuttle suitable for compensating for payload locality within the aircraft, through use of this shuttle increased aircraft stability can be achieved. Payloads in an aircraft generally need to be placed to achieve balance so that the center of gravity of the aircraft is not substantively impacted. With fixed structure aircraft, this is a load/unload problem. However, with a payload shuttle that can be positioned fore and aft as well as left and right of the center of gravity, uneven payload placement can be accommodated. By using sensors to determine the impact of a disposed payload, a payload shuttle can be moved to a position under the aircraft to compensate for the impact.

A moveable payload shuttle may also be used to adjust aircraft navigation. By moving a payload so that the aircraft lists in one direction or another the direction of the aircraft can be affected. A moveable payload shuttle may facilitate such payload movement. This may occur, for example when air flowing past the aircraft differently impacts one side of the aircraft than the other. Similarly, by causing the nose of the aircraft to drop relative to the tail, the aircraft may tend to be directed toward a lower altitude. Causing the tail of the aircraft to be lower than the nose may result in the aircraft climbing to a higher altitude. Other airflow compensation techniques may be employed with a moveable payload shuttle based on the size, shape, and propulsion system of the aircraft.

Embodiments of a gas lift-based aircraft may include lift gas generation capabilities. In the case of using hydrogen gas, a hydrogen generating system may be included to generate hydrogen gas from moisture available in the environment, such as from condensing ambient air, capturing rain and other sources of water. To achieve greater efficiency, such a hydrolysis system may be solar powered. The hydrogen produced may be supplied to the lift gas chamber to increase lift and/or replenish escaping gas and the like. Additionally, hydrogen may be produced to power a propulsion fan, an AC generator, and the like. Chambered hydrogen may also be consumed for such purposes Likewise, hydrogen that may be released from the chambers may be channeled through a combustion facility that uses the releasing hydrogen to generate electricity or otherwise power a propulsion engine, accessories, and the like.

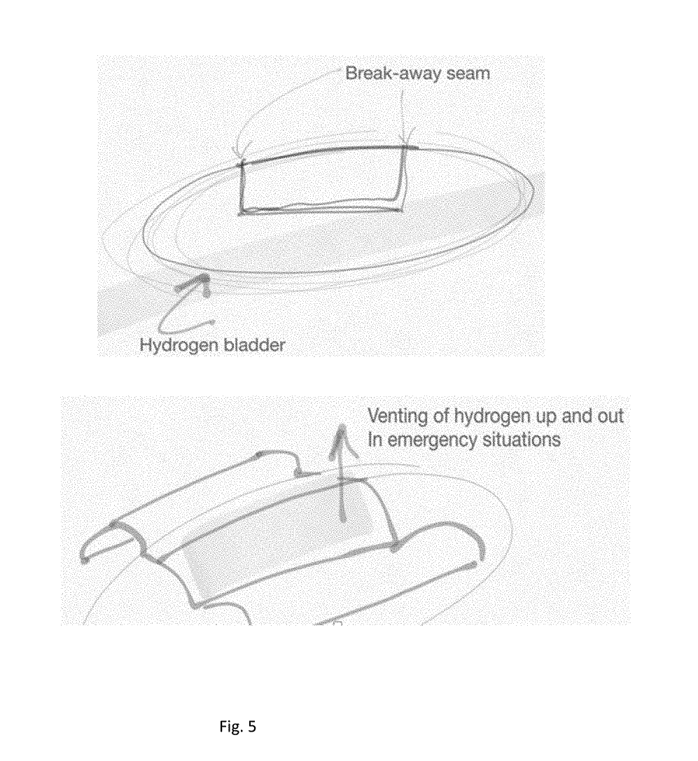

FIG. 5 depicts various hydrogen safety features and venting of the hydrogen is made possible under various conditions. In a case of chambered hydrogen combusting, upper chamber panels may facilitate releasing the hydrogen up and away from the aircraft and its payload quickly and safely. In one embodiment, a sub panel of the chamber may be configured with pressure-controlled break-away seams. The chamber may also be actively monitored for pressure, presence of combustion, conditions approaching danger of combustion and the like. Active valving may also be employed to prevent or compensate for excess pressure and the like. As an alternative to break away seams, hydrogen release panels may form a suitable seal to a main wall portion of the chamber wall when pressure within the chamber is below a release threshold. However, when the pressure increases above this threshold, the panels may separate from the main wall portion until the pressure is reduced; thereby not requiring human intervention to operate this safety feature. Hydrogen release panels may be configured as panels that overlap each other and/or a main wall portion of the chamber so that pressure over the threshold causes the panels to lift away and form an opening for the hydrogen gas to escape. Because hydrogen is lighter than the air around it, even during combustion it would rise upward away from the aircraft and its payload.

A vehicle may be configured with safety features. In embodiments, such as under power failure (e.g., failure of propulsion power, navigation power, operational power, complete power failure and the like), the vehicle may not fall to the ground uncontrollably. The vehicle may slowly descend due to its slightly less than buoyant state. In embodiments, the vehicle may be configured with a backup beacon with automatic dependent surveillance-broadcast (ADS-B) functionality may have its own separate power and can be activated manually or automatically to notify the surrounding airspace to facilitate locating a downed vehicle.

Additional risks include, without limitation lifting gas envelope tears. This may be due to external collisions, or in the presence of hydrogen in a catastrophic event, bursting due to internal pressure, and the like. In the event of an envelope tear, the vehicle's buoyancy state is compromised; however, the vehicle still has multiple measures to ensure safety.

In embodiments, an end goal of safety measures may be to protect the power distribution and main processors of the vehicle such that propulsion and navigation are still possible. In order to protect these items, the housing and containment of the vehicle's hardware resides in a modular ring separately enclosed and fire protected from the envelope. In embodiments, the vehicle's rigid structure is designed to encase any solar panels on the topside of the vehicle with, for example carbon fiber for stiffness and strength under such conditions to attempt to avoid these panels from being disrupted by an envelope tear. In embodiments, the yield pressure of the envelope compared to the rigid components of the vehicle is much less. In this way, by outfitting the vehicle with a vent area as described herein, even in an explosion of the vehicle lifting gas, the vent area of the will release far before the rigid structures of the vehicle are compromised.

In embodiments, when the vehicle is in a state of a compromised envelope, e.g., now has no lifting gas, but remaining systems are operational, there are more safety implementations that protect the people, payload, airspace and surrounding environment from a free fall of the vehicle.

In embodiments, the vehicle may contain a parachute, powered separately and optionally associated with the beacon and ADS-B hardware. The deployed parachute may aid in slowing the vehicle's decent, independently of the vehicle's main power distribution being protected or compromised. In the case where lifting gas of the vehicle is no longer sufficient to maintain the vehicle aloft, such as when the envelope has failed, the enclose safety ring described above herein may remain stabilized about its longitudinal axis, and propel its body with the comparable degrees of freedom as when the envelope was intact. The range may be limited due to the parachute. In embodiments, the remaining portion(s) of the vehicle may be capable of navigating to a safe landing area at a controlled descent. Furthermore, in the case with a failed parachute release, the vehicle is capable of rotating ninety degrees such that its nose is vertical. While the power system may not be capable of sustaining flight due to the weight of the vehicle, the vehicle has the ability to stabilize in this orientation, and maneuver analogous to the configuration of a quad copter. In this state, the vehicle can slow its decent and navigate itself to a safe area for landing.

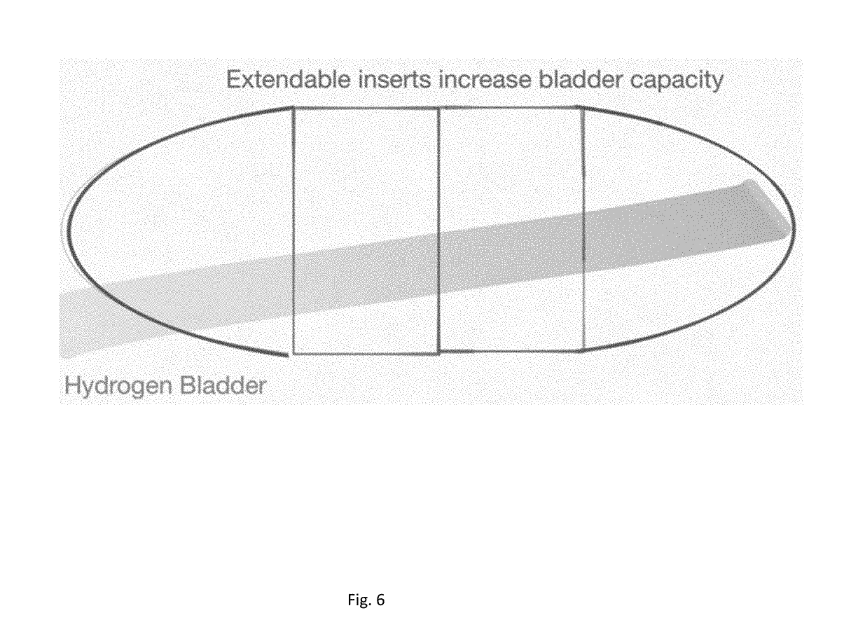

FIG. 6 depicts a modular dirigible lift gas chamber structure, through which increasing lift capacity can be accommodated. A lift gas chamber may be constructed with expandable/collapsible segments that may increase lift capacity through increasing the volume of gas that can be chambered. Segments may collapse along their surfaces, much like a stage curtain collapses on itself as it is raised. Other collapsible structures such as accordion style and the like may be suitable for use in an expandable lift gas chamber for use with an aircraft. Other options include sliding concentric panels, and the like. The benefits of such a chamber include that a single aircraft can be used for a wide range of payloads as well as where operating conditions dictate a smaller overall aircraft size. These expandable/collapsible panels may operate automatically based on payload, altitude, and the like.

In embodiments, constructing the envelope may include a process extrapolated from a previously known “berlin” method beginning with first sectioning the envelope design geometry into parts known as “gores”. These gores enable the envelope of the vehicle to be constructed in identical segments, as well as be scaled to various sizes. These gores are projected onto a 2D plane so that they can be traced. In embodiments that use heat-sealable material, such as Tedlar™, a 2D gore will be traced using a heating iron in order to seal the heat-sealable material in such a way that the 3D envelope will be formed with n gores.

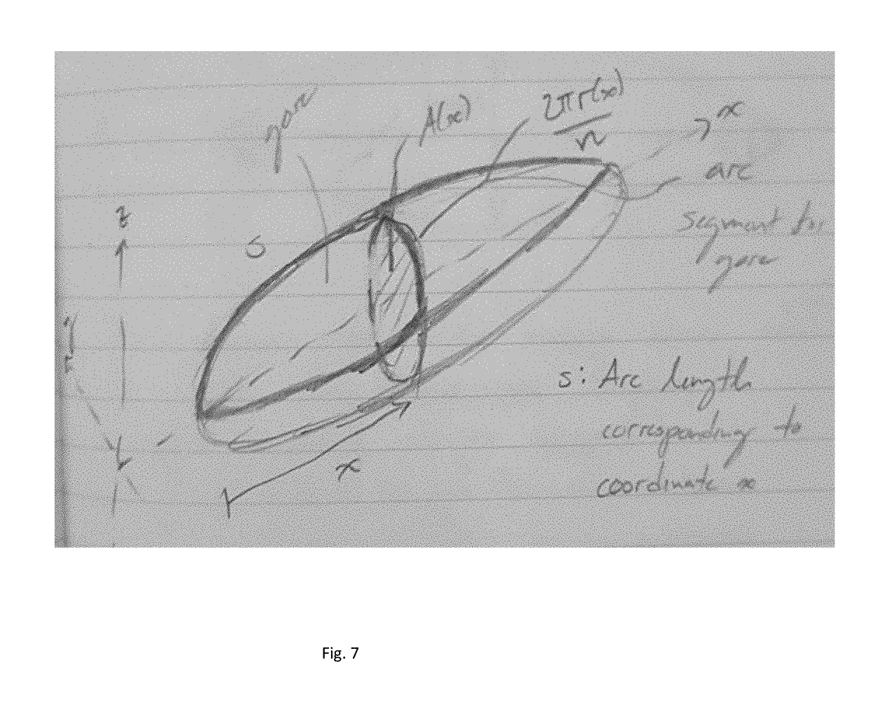

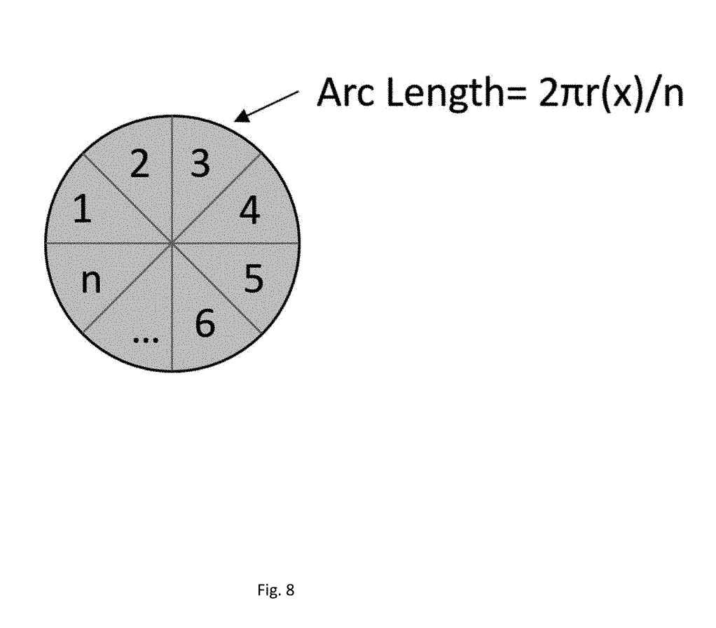

In order to construct the gore, consider a 3D body with a circular cross-section throughout its entire length. Next, consider an arbitrary distance x along the length of the body that has cross-section A(x)=πr(x)². This circular cross section can be broken into n equal arc segments. This is shown in FIGS. 7 and 8.

In order to project a gore for an n gore envelope onto a 2D plane, the arc length of the gore up to a distance x and the arc length of the arc segment of A(x) will be used. The arc length, s, of the gore up to a distance x is calculated in Equation (1) below:

$$s = {\int }_{0}^{x} \sqrt{1 + {( \frac{dy}{dx} )}^{2}} dx ≅ {\sum }_{i = 2}^{k} \sqrt{{( {x}_{i} - {x}_{i - 1} )}^{2} + {( {y}_{i} - {y}_{i - 1} )}^{2}} \qquad ( 1 )$$

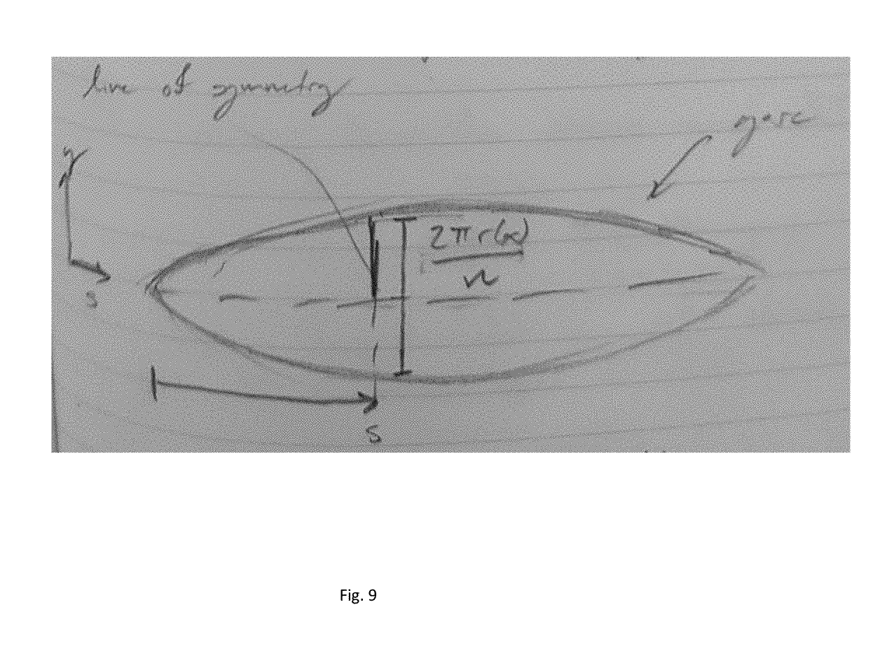

In Equation (1) above, the integral form of the arc length for an ellipse does not have a simple analytical solution. Therefore, a numerical approximation is used where the arc of the gore is partitioned into k points. As seen in FIG. 7, the arc of the arc segment has a height 2πr(x)/n. Due to the symmetry of the gore, the gore can be drawn using the arc length previously calculated and the coordinate ±πr(x)/n about the line of symmetry. This is shown in FIG. 9.

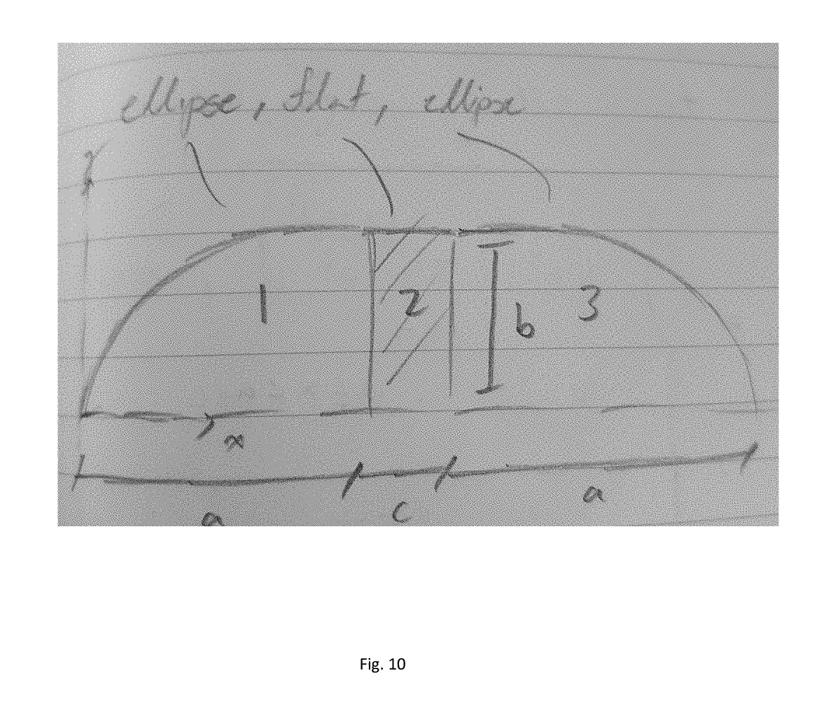

Using this, the only information needed to produce a gore is the radius of the cross-section of the envelope as a function of distance along the length and the number of gores desired. Because we have explicitly chosen the geometry of the envelope, the radius of a function of distance is known. For reference, the radius of envelope as a function of distance is shown below in Equation (2). The geometric values a, b, and c are defined in FIG. 10.

$$r ( x ) = \{ \begin{matrix}\sqrt{{b}^{2} ( 1 - {( \frac{x - a}{a} )}^{2} )} , & 0 \leq x < a \\ b , & a \leq x < a + c \\ \sqrt{{b}^{2} ( 1 - {( \frac{x - a - c}{a} )}^{2} )} , & a + c \leq x \leq 2 a + c\end{matrix} \qquad ( 2 )$$

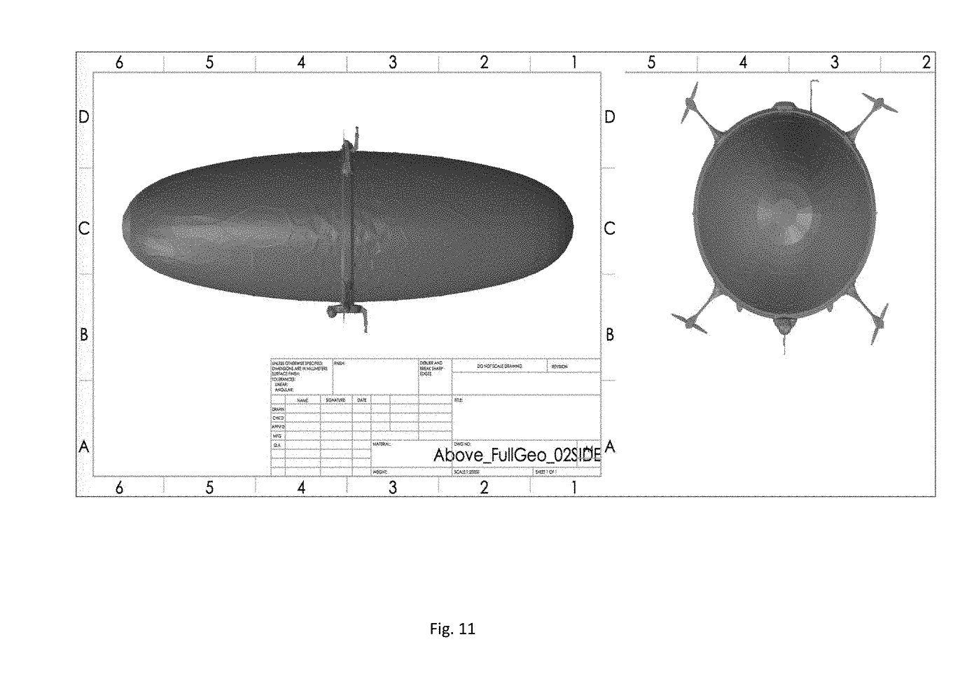

With these general dimensions, the gore of any envelope of this kind (ellipse, flat, and ellipse) can be produced. An exemplary envelope is depicted in FIG. 11. These processes enable efficient, repeatable, and scalable manufacturing for numerous vehicles. In embodiments, an expandable portion as described herein, may enable various sizes of envelopes to be quickly manufactured, such as to meet the different needs of different vehicles sizes, configurations, and payloads.

In embodiments, vehicle subsystems beyond the gas-containing envelope, such as a payload compartment, mechanical, electrical, passenger, the like may reside within or attached to a portion of a propulsion ring that may attach to the largest radius of the envelope. This ring modularity may facilitate separating the envelope from these vehicle subsystems so that different size envelopes may be mated with various rings carrying different payloads or configurations. These processes may enable efficient, repeatable, and scalable manufacturing for numerous vehicles.

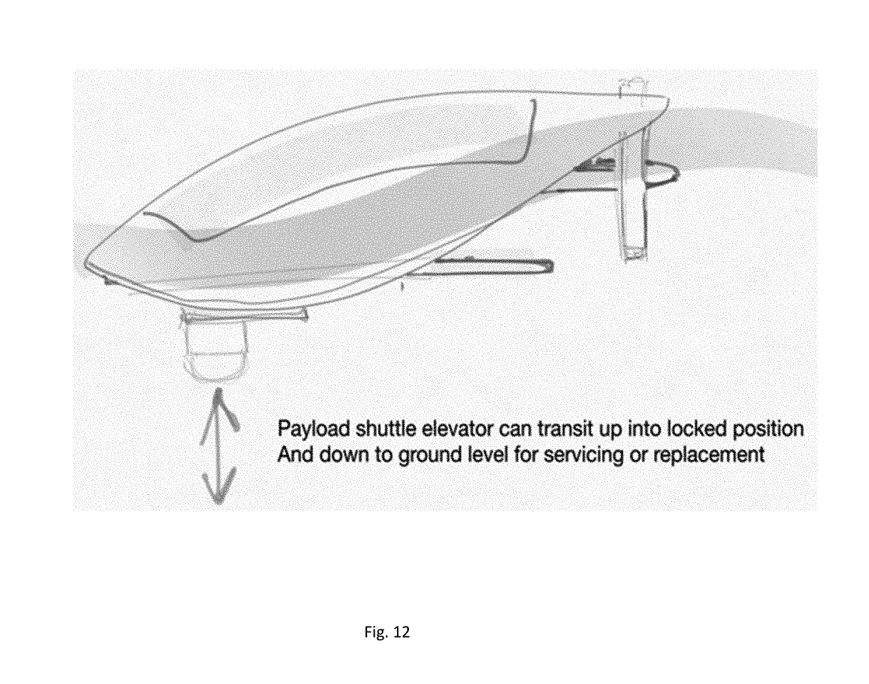

FIG. 12 depicts a payload elevator including an embodiment of an aircraft mechanism for transferring payload and the like between the aircraft and a land-based or other location. The payload elevator operates to eliminate a need for the aircraft to land or otherwise be tethered to a fixed location, such as loading platform or the like. The payload elevator may enable loading and unloading of the aircraft while the aircraft is hovering with or without tethering; thereby keeping the aircraft in service through loading/unloading and service activity.

A payload elevator may also be useful for maintaining a fixed altitude for surveillance type activity without requiring the aircraft to hover at the same altitude. In an example, the aircraft may be more stable at an altitude of 1500 feet than at 1000 feet, whereas the surveillance sensing equipment may be better used at 1000 feet. The surveillance equipment may be deployed on the elevator and lowered from the aircraft altitude to the surveillance altitude.

A payload elevator may further be configured with one or more aircraft platforms, such as a platform on which a helicopter or similar vertical lift-off and landing vehicle may land. Vehicles on such a platform may be used for delivery and retrieval of materials, to/from the aircraft, as a platform for servicing of the other aircraft or their personnel, as a platform for exchange of materials or personnel among aircraft using the platform, and the like. These platforms may also be used to transport other aircraft.

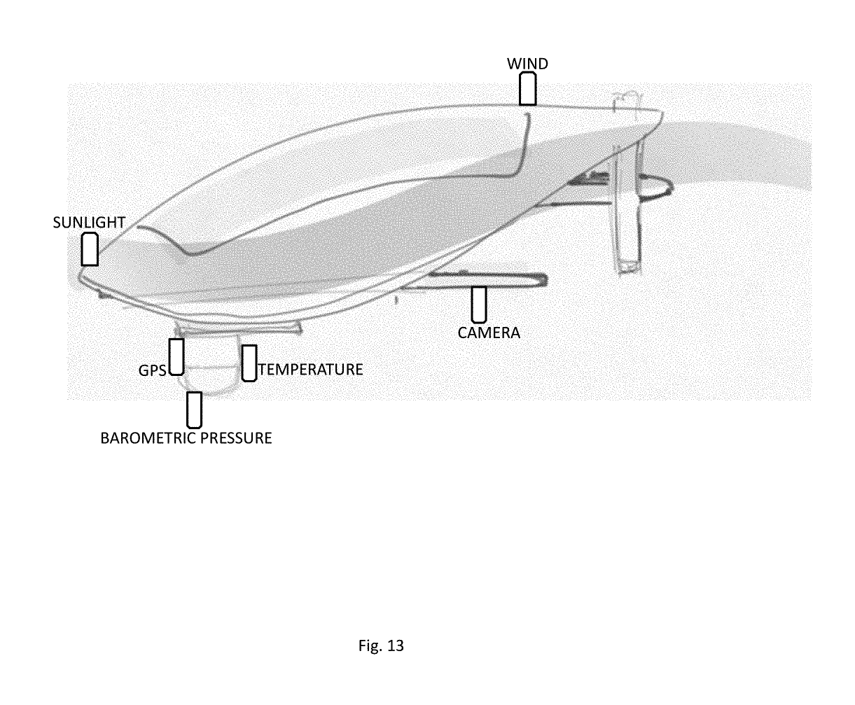

FIG. 13 depicts various sensing equipment on an aircraft with some or all the features described above. The sensing equipment may include LIDAR, RADAR, thermal, visual, and any other sensor technology. The outputs of the sensing equipment may be processed with algorithms that may facilitate z-stack correlative 3D reconstruction based on multi-modal sensors. Such an algorithm may be useful for combining multiple image and other inputs from sensors into a 3D reconstruction of a physical reality. LIDAR and RADAR sensor data may be correlated with an algorithm that allows for the correlation of multiple RADAR and LIDAR sensors' data with geospatial information. This information can be visualized as a single dataset. In addition, multi-sensor data from a plurality of sensors may be processed with an algorithm that facilitates correlating a multi-dimensional dataset from multiple sensor types with known geospatial information. The sensor data processing algorithms mentioned here may be applied to sensor data from any suitable source, such as drones, conventional planes, and the like, not only from sensors deployed with an aircraft as described herein.

In embodiments, this vehicle may be configured with a large array of sensors and cameras, which enable avenues of data fusion. These sensors may be time synchronized and their output data sets may be fused to calibrate various data sets against each other, including data sets output from a plurality of the array of sensors. Because the sensors and cameras may be operating in coordination with one another, more precise metrics may be quantified through fusion. Fused datasets may increase robustness and reliability and may have the ability to more accurately flag erroneous outliers due at least in part to an ability to cross reference redundant datasets. This environment may ensure accuracy of overlaying different datasets, and fusing multiple outputs.

In embodiments, a large size vehicle may make it possible to carry more sensors, such as in the payload as well as facilitate placing sensors at further distances from one another on the vehicle. Being able to have two or more independent cameras spread at a large distance that may vary due to turning of the vehicle allows the vehicle to carry a set of stereo cameras with a larger baseline, enabling building disparity maps with longer distances, and in turn allowing 3D reconstruction at longer ranges with similar accuracies.

Furthermore, real-time Simultaneous Localization and Mapping (SLAM) and object detection of the vehicle's mission assets may be localized. For large infrastructures, these may consist of repeated geometries such as transmission posts, or pipeline flanges. A localization of these components can generate a discretized path in 3-dimensional space. This may be stored as outputs for use by third-parties, utilized onboard for a more precise vehicle planning algorithm, and the like. Instead of matching large quantities of features, once the infrastructure's assets are detected and localized, these alone may be used to adjust the mission path. For localization, the vehicle may include RGB-d and LIDAR. The disparity map and LIDAR may be fused in real-time through use of a pre-calibration process and enable a more robust and precise solution to point cloud generation of an area of interest.

These sensors may also be used to detect power lines. An advantage in detecting power lines is that the lines sag due to the force of gravity in between towers. This presents itself as an advantage because visual detection of the lowest sag point can be used to determine a gravitational force vector. After determining and mapping a section of the sagging power lines, a gravity vector, such as relative to the vehicle may be constructed from the detected lowest sag point. A precise determination of this gravity vector may be useful for IMU and onboard sensor calibration, such as drift zeroing and recalibration. A gravity vector may be used for various applications, some of which may be described herein.

In embodiments, pre-calibration may enable various fusion of sensors. As an example even after large computational processes have run such as generating orthomosaics or 3D reconstruction, transformed input images may be applied to various other camera images and sensor output. In embodiments, once the various RGB images have reconstructed a power line, a thermal image may also be transformed and projected into 3D space quickly through use of the previously stored image manipulation with the RGB images. This thermal reconstruction may then be overlaid and compared in 3D space as opposed to relying on determining features and points of interest in much lower resolution images, such as thermal data.

In embodiments, a workflow for part segmentation analysis and assembly analysis may be deployable to various image/sensor data analysis applications. Portions of the workflow may include robust object detection and classification algorithms. Expansions to these algorithms may be applied to power and transmission lines, pipelines, and others. Access to assembly knowledge of these structures' build and components may facilitate cross referencing part metrics, assembly procedures, and geometric constraints, and may give insight of how well the structure is assembled and its state of operation and wear, including determining if there are any inconsistencies that may need to be flagged. Through itemization of these parts, and their metrics, simple tables can be generated that may facilitate tracking characteristics of the structure of interest over time. This may enable wear monitoring and change detection through a much simpler and lighter-weight process.

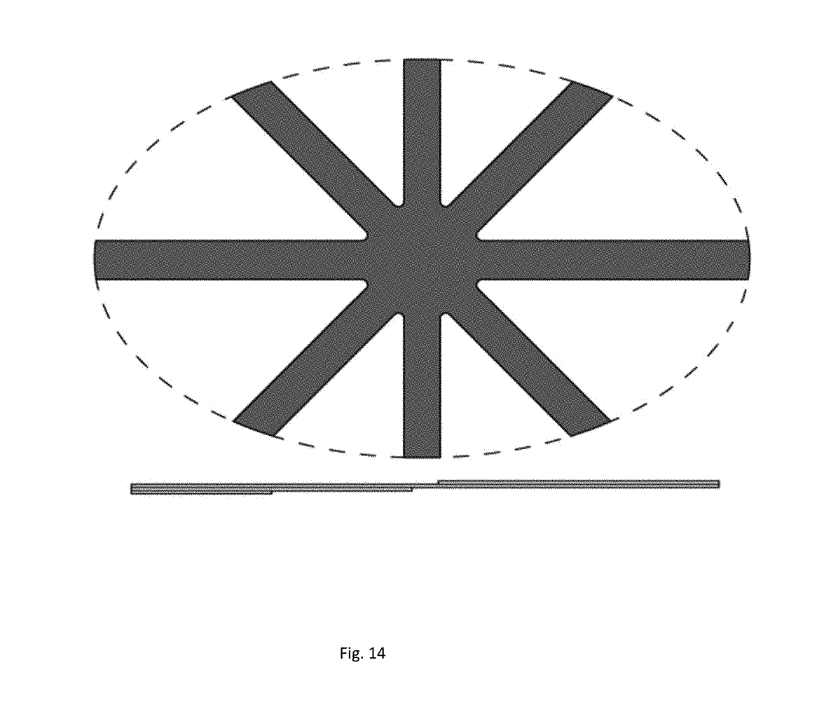

FIG. 14 depicts a portion of a selective multi-thickness wall of an aircraft lift gas chamber. An aircraft with a lift gas chamber may be constructed of composite material that has selective portions enforced through chemical interaction of a base flexible layer with a second ingredient applied to the base layer during a manufacturing process. The selective portions may result in a semi-rigid structure that supports the flexible portions when sufficient lift gas pressure is not present to maintain its form. Rather than using an ultrasonic welding or other technique to combine semi-rigid and flexible portions, a process by which selection portions of a flexible base material may be made rigid through a chemical interaction process. The select portions may be determined to form a type of superstructure for the lift gas chamber. Also unlike overlaying a flexible membrane over a semi-rigid structure, the methods described here enable production of a lift gas chamber through a chemical interaction or bonding process.

An exemplary manufacturing process may include starting with a form that has worked into it reliefs where the select semi-rigid portion of the chamber is to be formed. A base layer may be applied to the exterior of the form and a second ingredient may be applied through the reliefs from the interior to form the semi-rigid portions. An alternative manufacturing process may have the flexible base layer applied to an interior or concave portion of a form and the second ingredient applied through reliefs in the form from the exterior or convex side of the form. Other manufacturing processes with or without forms may also be appropriate.

In embodiments, an exemplary process and materials for constructing the gas envelope portion of the chamber is now described. While this example references specific third-party products, comparable materials with similar capabilities could also be used. This embodiment is not intended to be the only process for constructing a gas envelope of the vehicle described variously herein.

In embodiments, a composite multi-layer envelope may include an innermost layer comprising heat sealable TST20SG4 Tedlar™ which is lightweight and has resistance to gas permeation. It will serve as the bladder of the envelope containing the lifting gas. When this film is heated to 450° F. it can be sealed onto itself forming a seal. An intermediate layer may be formed from Dacron™ Fabric, also known as Polyethylene Terephthalate. In embodiments, this may be the structural layer of the envelope. Its low weight and high tensile strength is suitable for this application, helping the envelope maintain its shape and ensuring that the envelope can withstand strong headwinds. An outer layer of the envelope may be made with aircraft grade TWH10BS3 Tedlar™. This layer serves as a protective layer for the envelope. This layer may be coated with a UV ray absorbing material to help the envelope retain its color and integrity.

In embodiments, an adhesive may be used to join the three separate layers described above. One exemplary adhesive, Bostik™ F10-316™ is suitable for adhering films and fabric. It requires a low temperature to activate the adhesive, 300° F. to 350° F. and has a short cure time ranging from 5 to 2 minutes. Another exemplary adhesive, 3M™ spray adhesive is lower cost and about half the weight of the Bostik™ adhesive. In embodiments, an air valve will be attached and sealed to the outer layer of Tedlar™. This valve will be supported using carbon fiber strips to distribute stress around the valve in order to prevent tears.

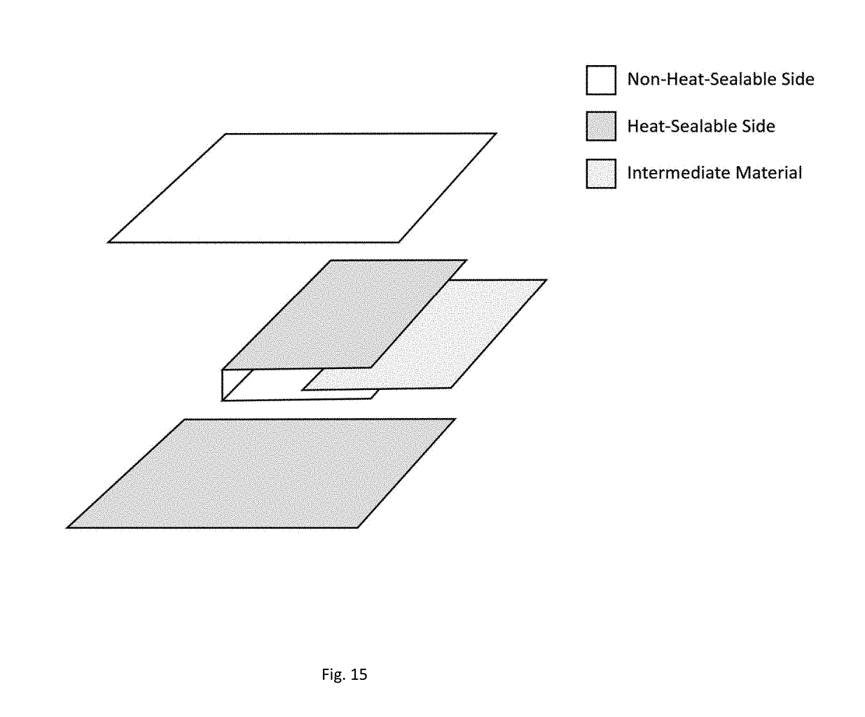

As described above, an envelope may be created by combining multiple gores. Such a method may consist of using layers of the Tedlar™ in such a way that takes advantage of the symmetry of the gore shape. First, a rectangular layer will be laid out as flat and secured. Next, for an envelope with more than 2 gores, a rectangular layer that is half the width of the base layer will be placed. This half layer will be a folded layer. The fold of this half layer will be towards the center of the base layer. Every half layer added will increase the gore count by 1. In embodiments, the heat-sealable Tedlar™ can be sealed to itself on both sides, however, sealing to one side is also possible. In order to avoid fusion in incorrect locations, ruining the shape, an intermediate material will be placed within each half layer. An illustration of this process for a 3 gore envelope is shown in FIG. 15.

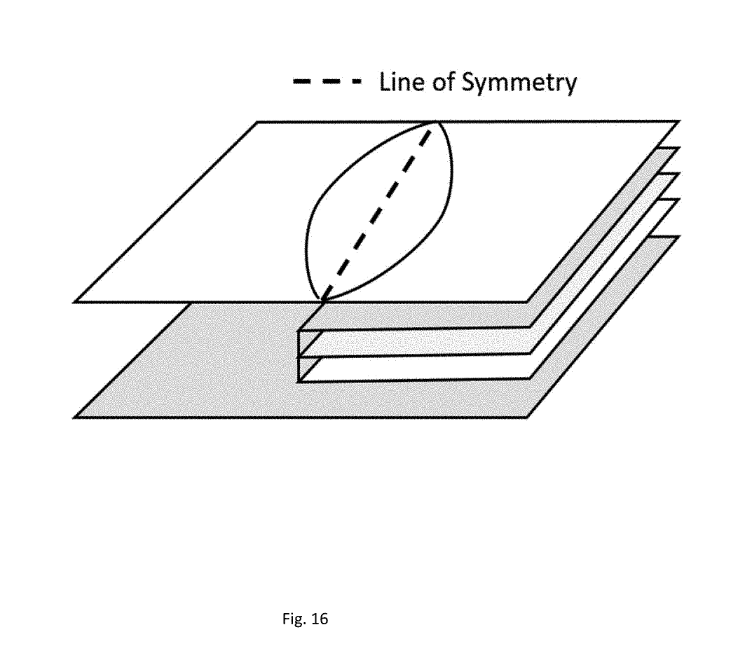

Once the Tedlar™ has been layered, such as in the way as shown in FIG. 15, a cutout of the gore shape that was produced earlier can be placed with the line of symmetry along the midline of the heat sealable material (the line of symmetry will be aligned with the fold of the inner half layers). Then, a heating iron is used to trace the gore outline as depicted in FIG. 16. The heat-sealable material will then form the envelope shape with n gores (2 corresponding to the flat layers and n−2 gores corresponding to inner half layers).

As described herein two outer layers can be adhered to the bladder. Methods of attaching the two outer layers may include creating n gores and stitching them together around the bladder, and the like.

In embodiments, a lightweight matrix of layers may provide functionalities including gas sealing, tear resistance and sheer strength, and UV resistance. In embodiments, a lightweight carbon fiber reinforced bracing structure may provide benefits including energy damping, structural rigidity, and rigid envelope exoskeleton.

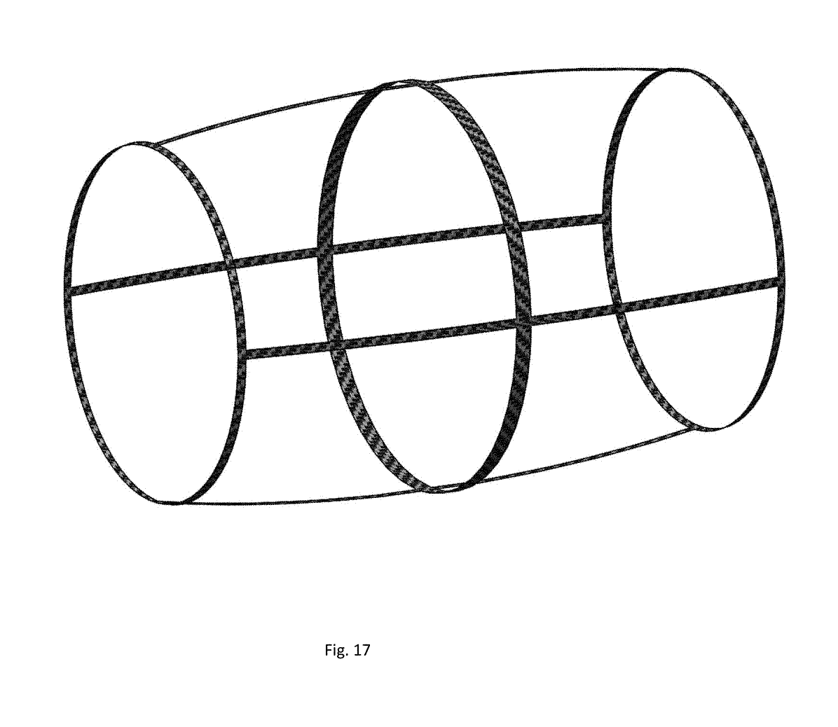

In order to help provide structural support for the envelope shape and the payload ring, there will be a carbon fiber frame around the envelope. The frame will provide a point to mount the payload ring and an interface for incorporating monitoring systems. FIG. 17 depicts an exemplary design of a frame that helps to minimize the weight of the frame, while distributing stress from the payload over the entire envelope.

In embodiments, creating a carbon fiber frame may be accomplished by using an inflated envelope as a form over which carbon fiber strips in the shape of the desired frame can be placed and set. In embodiments, an exemplary process to manufacture the frame, the envelope may be inflated to provide the shape of the overall UAV. The frame may be layered and adhered to the outer surface of the envelope. The carbon fiber may be cut into strips the width of the frame sections. These strips may be layered over the surface of the envelope. An example of this process is as follows:

1. Spread a small layer of resin in order to hold the carbon fiber in place.

2. Lay the strips of carbon fiber over the resin, ensuring overlap at the ends of the strips for strength.

3. Spread resin over the top of the carbon fiber layer and use a squeegee to force the resin into the fiber.

4. Lay another layer of carbon fiber strips and repeat with resin

5. Once the desired layers and resin are added, the frame is left for 24 hours for the resin to set.

6. Once it is set, it can be sanded and finished to provide the desired final result.

The above process can be used to add as many layers as necessary. In embodiments, two or more layers of carbon fiber may be used. Fewer layers keep down weight and maintain flexibility. More layers may increase weight, but also may increase strength, such as for increasing payload capability. The frame may also contain a pressure sensor to monitor the inside of the envelope.

1. A method of propulsion of an unmanned vehicle, comprising:
detecting a plurality of altitude differentiated wind vectors;
determining and ordering a subset of the wind vectors that provide directional air flow from a first geographic region to a second geographic region;
configuring the unmanned vehicle for facilitating movement of the vehicle along a first vector of the plurality of wind vectors;
adjusting an altitude of the vehicle to correspond to an altitude of the first wind vector; and
repeating the configuring and adjusting for the subset of plurality of wind vectors based on a flight plan that includes at least one of a duration and distance for each of the ordered subset of the wind vectors.

2. The method of claim 1, wherein detecting a plurality of altitude differentiated wind vectors is based on a weather map.

3. The method of claim 1, wherein the flight plan is based on a combination of weather maps, airspace occupancy information for at least a portion of the airspace along the flight plan, and weather conditions sensed proximal to the vehicle.

4. The method of claim 1, wherein the flight plan includes at least one location for adjusting an altitude of the vehicle for each of the subset of wind vectors.

5. The method of claim 4, wherein the at least one location is a location of entry into the wind vector.

6. The method of claim 4, wherein the at least one location is a location of exit from the wind vector.

7. The method of claim 4, wherein the at least one location is based on air pressure.

8. The method of claim 1, wherein adjusting altitude includes adjusting a buoyancy of the vehicle.

9. The method of claim 1, wherein adjusting altitude includes adjusting a shape of a portion of the vehicle to induce at least one of differential air pressure lift or altitude reduction.

10. The method of claim 1, where the flight plan is based on at least two of air temperature, air pressure, relative humidity, barometric pressure, temporal wind patterns, cloud patterns, target destination arrival time.

11. The method of claim 1, wherein the flight plan is based on at least two of terrain along the travel route, manmade structures, flight timing, aircraft traffic patterns, and classification of airspace at a plurality of altitudes.

12. The method of claim 1, further comprising adjusting the flight plan based on updates to information on which the flight plan is based, including conditions proximal to the vehicle that are sensed by vehicle-mounted sensors.

13. The method of claim 12, wherein the vehicle mounted sensors that facilitate adjusting the flight plan include directional pilot tubes.

14. The method of claim 13, wherein the directional pilot tubes are configured to produce a three-dimensional airspeed vector.

15. The method of claim 1, wherein the flight plan is based on a measure of external forces acting on the vehicle.

16. The method of claim 15, wherein the measure of external forces comprises dead reckoning information generated by data gathered with an Inertial Measurement Unit mounted to the vehicle.

17. The method of claim 1, wherein configuring the unmanned vehicle includes orienting the vehicle to receive the wind along a broad side of the vehicle.

18. The method of claim 1, wherein configuring the unmanned vehicle includes applying preconfigured drag and lift coefficients to a vehicle orientation algorithm that determines an external portion of the vehicle to receive the wind and adjusting the vehicle orientation so that the determined external portion receives the wind.

19. The method of claim 1, wherein configuring the unmanned vehicle includes controlling wind-induced rotation of at least one propulsion rotor with variable braking forces.

20. A method of unmanned vehicle surveillance comprising:
determining altitude differentiated wind patterns proximal to a surveillance region;
ordering a portion of the wind patterns to facilitate navigation over the surveillance region;
configuring a propulsion system of an unmanned vehicle for facilitating movement of the vehicle along a first pattern of the portion of the wind patterns;
adjusting an altitude of the vehicle to correspond to an altitude of the first wind pattern in the portion of wind patterns; and
repeating the configuring and adjusting for the ordered set of wind patterns based on a surveillance plan that includes at least one of a duration and distance for each of the ordered portion of the wind patterns.

21.-49. (canceled)
